(19) United States
(12) Patent Application Publication
(10) Pub. No.: US 2014/0120785 A1
(43) Pub. Date: May 1, 2014

(54) IN-FLIGHT ENTERTAINMENT SYSTEM FOR AN AIRCRAFT

(71) Applicant: Winchester Electronics Corporation, Wallingford, CT (US)

(72) Inventors: John E. BENHAM, Torrington, CT (US); David J. CAMELIO, Foxboro, MA (US)

(73) Assignee: Winchester Electronics Corporation, Wallingford, CT (US)

(21) Appl. No.: 14/062,173

(22) Filed: Oct. 24, 2013

Related U.S. Application Data
(60) Provisional application No. 61/717,950, filed on Oct. 24, 2012.

(51) Int. Cl. H01R 4/18; H01R 43/26

(52) U.S. Cl. CPC H01R 4/183; H01R 43/26
USPC 439/877; 29/874

(57) ABSTRACT

In one aspect, a method for securing a signal conductor to a contact is provided. The method includes obtaining a contact having a first end and a second end, wherein the second end comprises a crimp area having a wall that defines a cavity and a plurality of cold flow holes are formed in the wall and surround at least a portion of the cavity; inserting an end of the signal conductor into the cavity; and after inserting the end of the signal conductor into the cavity, crimping the crimp area so that the signal conductor cold flows into at least one of the cold flow holes.

This application claims the benefit of U.S. provisional patent application No. 61/717,950, filed on Oct. 24, 2012, which is incorporated by reference.

### BACKGROUND

As aircrafts have evolved, so have the in-flight entertainment (IFE) systems. For example, some IFE systems provide Wi-Fi and/or other wireless communications availability to the passengers of the aircraft. To facilitate wireless communication in the passenger compartment an antenna in the form of a cable may run the length of the aircraft fuselage. Such a cable may be a coaxial (or “coax”) cable that has gaps or slots in its outer conductor to allow radio signals to leak into or out of the cable along its entire length (such a cable is sometimes referred to as a “leaky feeder”).

The use of a lightweight antenna cable (e.g., leaky feeder) is desired. In many embodiments, the signal conductor of the antenna cable consists primarily of aluminum. Passenger aircraft cabin layouts can vary from carrier to carrier, and, thus, the antenna cable may need to be tailored for each cabin. Such tailoring may include terminating one or both ends of the antenna cable at an RF connector (e.g., physically connecting the end of the cable to a contact pin of the RF connector) after the cable has been properly positioned in the aircraft cabin. The RF connector may be a Type N connector.

It is desirable for the RF connectors to perform well at high frequencies (e.g. at least up to 6 GHz). Typically, the contact pin of the RF connector is made from copper or copper alloy and a hex crimp is used to crimp the contact pin of the RF connector to the signal conductor of the cable (e.g., the center conductor of a coaxial cable). Due to the compressive strength of aluminum being less than the compressive strength of copper and copper alloys, minute spring back of the copper contact pin may create a loose crimp and the physical and electrical connection between the aluminum signal conductor and copper contact pin may degrade over time, particularly in a vibratory environment like an aircraft cabin.

Crimping a copper based contact pin to an aluminum signal conductor is typically achieved by large deformation of the crimp area, however, doing so greatly impacts RF performance of the connector and functional bandwidth of the antenna cable.

### SUMMARY

This disclosure discloses, among other things, an improved IFE for an aircraft. In some embodiments, the IFE includes a cable (e.g., an antenna cable or a cable for connecting a component of the IFE, such as for example a transceiver, to the antenna cable) having a signal conductor that is terminated by a cold flow contact of a connector (e.g. a cold flow contact pin of an RF connector). In some embodiments, the cold flow contact has a contact feature in a crimp region of the contact in the form of cold flow holes (e.g., radially spaced holes) or in the form of cold flow grooves formed in a wall of the crimp region. As a result of crimping (e.g., hex crimping) the crimp region when an end of the signal conductor is disposed in a cavity formed by the crimp region, the signal conductor cold flows into the cold flow holes and/or grooves. This feature provides a metal to metal engagement that securely terminates the signal conductor. A standard hex crimping tool may be used to hex crimp the crimp region with the signal conductor. These features are advantageous as they, among other things, reduce the problems described in the background above.

In some embodiments, as the crimp (e.g., hex crimp) is formed, radially placed cold flow holes deform creating asperities around the inner diameter of the radially placed holes between the contact and the signal conductor creating a secure crimp. A cold flow crimp secures the contact to the signal conductor with retention greater than the tensile strength of the signal conductor and supports field termination of a leaky/antenna cable for IFE upgrades.

In another aspect, a contact for connecting to a signal conductor is provided. In some embodiments, the contact comprises a first end and a second end opposite the first end, wherein the second end comprises a crimp area having a wall that defines a cavity for receiving an end of the signal conductor, and a plurality of cold flow holes are formed in the wall and surround at least a portion of the cavity.

In another aspect, a method for securing a signal conductor to a contact is disclosed. In some embodiment the method includes: obtaining a contact having a first end and a second end, wherein the second end comprises a crimp area having a wall that defines a cavity and a plurality of cold flow holes are formed in the wall and surround at least a portion of the cavity; inserting an end of the signal conductor into the cavity; and after inserting the end of the signal conductor into the cavity, crimping the crimp area so that the signal conductor cold flows into at least one of the cold flow holes.

The above and other aspects and embodiments are described below.

### BRIEF DESCRIPTION OF THE DRAWINGS

FIG. 1 is a view of a contact pin according to some embodiments.

FIG. 2 is a close up view of the crimp area of the contact pin shown in FIG. 1.

FIG. 3 is a view showing a signal conductor inserted into a cavity formed by the crimp area.

FIG. 4 is a cross-sectional view of the crimp area after the crimp area has been crimped to the signal conductor.

FIG. 5 is a close up view of the crimp area according to another embodiment.

### DETAILED DESCRIPTION

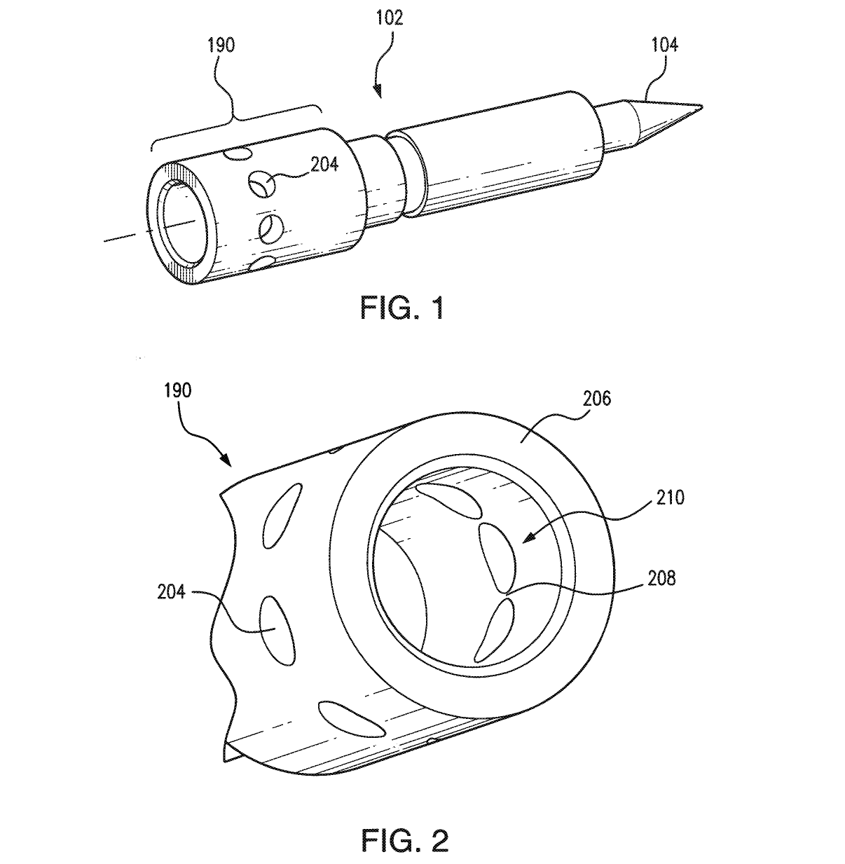

FIG. 1 is a view of a contact in the form of a contact pin 102 (e.g., a contract pin of a connector, such as a Type N connector) according to some embodiments. As shown in FIG. 1, in some embodiments contact pin 102 is elongate (i.e., its length is significantly greater than its width), has a pointed end 104, and has a crimp area 190. The crimp area 190 is located at the end of the contact pin opposite of the pointed end 104.

FIG. 2 is a close up view of the crimp area 190 of the contact pin 102, according to some embodiments. In the illustrated embodiment, crimp area 190 includes a contact feature in the form of holes 204 (a.k.a., “cold flow holes”) that are formed in the wall 206 that defines the crimp area 190. In the embodiment shown, the holes are radially placed 45 degrees apart and are sized to leave a web area 208 between the radial placed holes between 0.003 inches to 0.010 inches. As shown in FIG. 2, the wall 206 of the crimp area 190 defines a cavity 210 for receiving an end of a signal conductor of a cable (e.g., a coaxial antenna cable that is used in an IFE of an aircraft as described in the background). The cold flow holes 204 may be placed to be in the middle of the crimp area (e.g., in the middle of the wall 206).

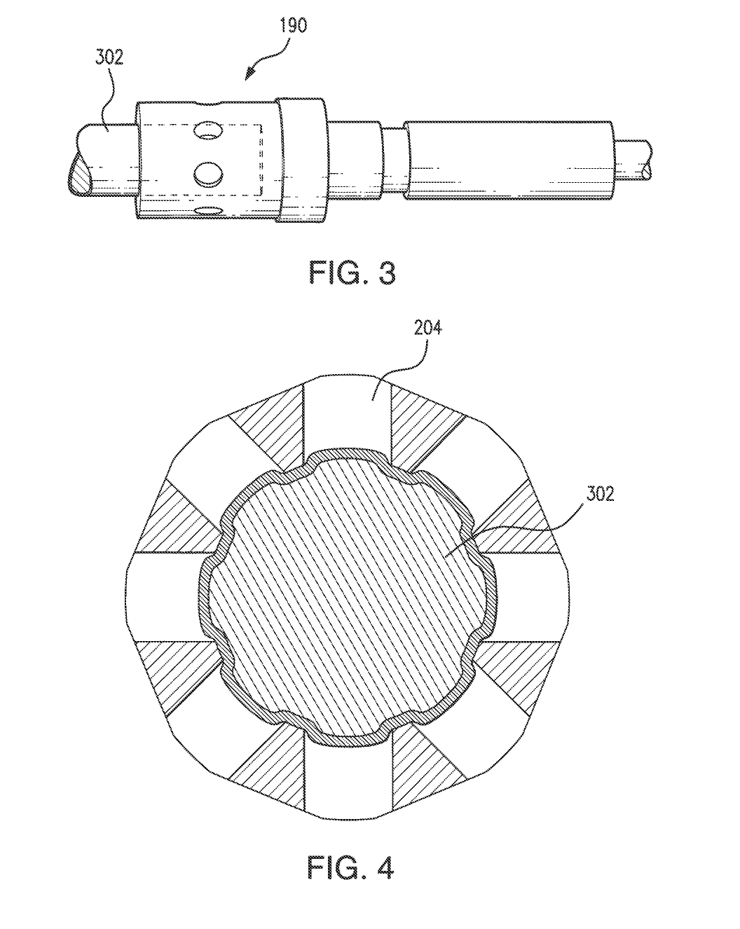

FIG. 3 shows an end of a signal conductor 302 inserted into the cavity 210. Signal conductor 302 may be a signal conductor of a coaxial cable and may be formed primarily from aluminum (e.g., signal conductor 302 may be a copper plated aluminum wire). After insertion of the end of the signal conductor 302 into cavity 210, the signal conductor 302 can be mechanically and electrically connected to contact pin 102 by crimping (e.g., hex crimping) the crimp area 190. FIG. 3 also shows a hex crimp that has been formed in the crimp area 190 by crimp tool having a hex size of 0.151 and width of 0.185. The hex crimp compression is 8% to 12% of the signal conductor wire and contact square area. Thus, about 8 to 12% of the signal conductor flows into the contact feature (e.g., hole and/or groove).

FIG. 4 shows a cross section of the crimp area 190 shown in FIG. 2 after the crimp area has been crimped to the signal conductor 302. As shown in FIG. 4, a small amount of the signal conductor 302 flows into one or more of the cold flow holes 204. Additionally, as described above, in some embodiments as the crimp (e.g., hex crimp) is formed, the holes 204 deform creating asperities around the inner diameter of the radially placed holes between the contact and the signal conductor, thereby creating a secure mechanical connection between the signal conductor 302 and the contact pin 102. The asperities' region of the cold flow hole is the intersection of the inner diameter of the contact and radially placed holes and do not break through the surface (e.g., the plating) of the signal conductor.

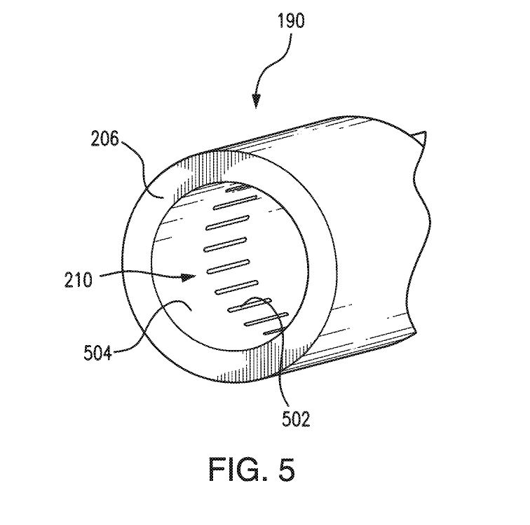

FIG. 5 illustrates another embodiment of crimp area 190. As shown in FIG. 5, a contact feature in the form of a plurality of grooves 502 may be formed in the inner surface 504 of wall 206, which surface defines cavity 210. As with holes 204, when an end of a signal conductor 302 that is disposed within cavity 210 is crimped by crimping crimp area 190, some of the signal conductor 302 will cold flow into grooves 502.

The above described cold flow crimp methodology may secure the contact pin 102 to the signal conductor 302 with retention greater than the tensile of the conductor and supports field termination of a leaky/antenna cable for IFE upgrades.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

1. An aircraft comprising an in-flight entertainment (IFE) system, the IFE system comprising:
a cable comprising a signal conductor; and
a cold flow contact for receiving an end of the signal conductor, wherein the cold flow contact pin comprises:
a crimp area comprising a wall that defines a cavity in which the end of the signal conductor is disposed, and
the wall includes a contact feature into which a portion of the signal conductor has flown.

2. The aircraft of claim 1, wherein the contact feature comprises a plurality of cold flow holes formed in the wall and extending from the outer surface of the wall to the inner surface of the wall.

3. The aircraft of claim 2, wherein the plurality of holes consists of three or more holes.

4. The aircraft of claim 3, wherein each hole is spaced at least 22.5 degrees apart from an adjacent hole.

5. The aircraft of claim 1, wherein the cable is an antenna cable.

6. The aircraft of claim 1, wherein the crimped area was crimped.

7. A contact for connecting to a signal conductor, comprising
a first end; and
a second end opposite the first end, wherein
the second end comprises a crimp area having a wall that defines a cavity for receiving an end of the signal conductor, and
a plurality of cold flow holes are formed in the wall and surround at least a portion of the cavity.

8. The contact of claim 7, wherein the contact is a contact pin of a Type N RF connector.

9. A method for securing a signal conductor to a contact, comprising:
obtaining a contact having a first end and a second end, wherein the second end comprises a crimp area having a wall that defines a cavity and a plurality of cold flow holes are formed in the wall and surround at least a portion of the cavity;
inserting an end of the signal conductor into the cavity; and
after inserting the end of the signal conductor into the cavity, crimping the crimp area so that the signal conductor cold flows into at least one of the cold flow holes.

10. The method of claim 9, wherein the contact is a contact pin of a Type N RF connector.
